(19) United States
(12) Patent Application Publication
(10) Pub. No.: US 2016/0013672 A1
(43) Pub. Date: Jan. 14, 2016

(54) POWER GENERATING COLUMN STRUCTURE

(71) Applicant: SUNVALUE CO., LTD., Kaohsiung City (TW)

(72) Inventors: Sheng Tsai Tseng, Kaohsiung City (TW); Sheng Lan Tseng, Kaohsiung City (TW)

(21) Appl. No.: 14/628,944

(22) Filed: Feb. 23, 2015

(30) Foreign Application Priority Data
Jul. 14, 2014 (TW) 103212458

(51) Int. Cl. H02J 7/00; H02J 7/35; H02J 7/02

(52) U.S. Cl. CPC H02J 7/0042; H02J 7/025; H02J 7/0013; H02J 7/355

(57) ABSTRACT

Disclosed is a power generating column structure including a skeleton, at least one solar plate, at least one thin power saving billboard, upper and lower sidewall bodies, a charging unit, an intermediate charging region and an electrical connection circuit. The solar plate, the thin power saving billboard and the upper and lower sidewall bodies are provided on the outer surface of the skeleton which includes first, second and third horizontal partitions horizontally provided at different positions. The intermediate charging region is sandwiched between the second and third horizontal partitions. The charging unit including charging sockets is located in the intermediate charging region for charging. The electrical connection circuit is installed inside the electrical connection circuit to transfer electrical power generated by the solar plate to the thin power saving billboard and the charging sockets. Thus, both functions of charging and displaying advertisement are provided.

### CROSS-REFERENCE TO RELATED APPLICATION

This application claims the priority of Taiwanese patent application No. 103212458, filed on Jul. 14, 2014, which is incorporated herewith by reference.

### BACKGROUND OF THE INVENTION

1. Field of the Invention

The present invention generally relates to a power generating column structure, and more specifically to a power generating column structure with a column shape and having an intermediate charging region provided with charging sockets such that solar power is transformed into electric power supplied to the charging sockets so as to provide both charging and displaying advertisement effects.

2. The Prior Arts

As various and powerful application functions are successfully developed and sold, mobile electronic devices being much lighter, thinner, shorter and smaller have gain great popularity for its convenience. In particular, mobile phones almost become a must-have for everybody now. People not only frequently use the mobile phones to talk, but also surf the webs, play on-line games, read electronic articles and enjoy various entertaining function like watching video programs. These electronic functions need built-in batteries to supply sufficient electric power to work and Lithium based batteries are one of the most commonly used because of light weight, large electrical capacity and no adverse memory effect. However, the power consumption greatly increases as many applications are frequently executed such that the users have to charge their mobile phones in a short period of time such as less than one day. It generally takes some to charge the batteries and it is often difficult to find a suitable charging socket in an indoor or outdoor site. As a result, people who often travel for business encounter inconvenience for charging.

Currently, only some specific public occasions such as airports and urbane traffic stops, provides charging sockets for passengers. However, the number of charging sockets is few such that the users still face inconvenience of charging their mobile phones.

Therefore, it is greatly needed to provide a new power generating column structure using solar power to supply the charge power for charging the electronic devices. Especially, the column structure are provided with the charging sockets, which do not occupy too much space, and the column shape can further enhance decorative and aesthetic effect, thereby overcoming the above problems in the prior arts.

### SUMMARY OF THE INVENTION

The primary objective of the present invention is to provide a power generating column structure for charging and displaying advertisement. The power generating column structure comprises a skeleton, at least one solar plate, at least one thin power saving billboard, a plurality of upper sidewall bodies, a plurality of lower sidewall bodies, a charging unit, an intermediate charging region and an electrical connection circuit. The solar plate, the thin power saving billboard and the upper sidewall bodies and the lower sidewall bodies are provided on the outer surface of the skeleton. The intermediate charging region is located inside the open space of the middle of the power generating column structure, and the charging unit comprising charging sockets is in the intermediate charging region, each charging socket for charging electric devices.

The skeleton comprises a plurality of rod-like metal pieces, a first horizontal partition, a second horizontal partition and a third horizontal partition. The rod-like metal pieces are jointed together by means of soldering or locking to construct a vertical column having a plurality of hollow cells on each side like a trellis. Preferably, the rod-like metal piece is implemented by a solid or hollow piece made of iron, stainless steel or aluminum alloy, or alternatively a C-shaped or H-shaped piece. The first, second and third horizontal partitions are horizontally provided at different positions inside the vertical column. More specifically, the first horizontal partition is higher than the second horizontal partition and the second horizontal partition is higher than the third horizontal partition. In particular, the specific region sandwiched by the second horizontal partition and the third horizontal partition forms the intermediate charging region.

The solar plate is partly transparent and able to convert solar power into electricity. It is preferred that the solar plate is configured on the top surface of the skeleton or on the sidewall near the top of the skeleton so as to increase the effective exposure area for sunlight.

The thin power saving billboard can be powered by electricity from general city power and/or generated by the solar plate such that static pictures, movies or animations are normally and clearly displayed. It is preferred that the billboard is configured to enclose the sidewalls of the top of the skeleton, thereby enhancing advertisement effect. Additionally, the billboard further comprises a light guiding film, which converts the side light from the solar plate into a plane light source served as the light source for displaying, especially during the daytime. In other words, the billboard can be supplied by the plane light source generated by the light guiding film at day and powered by electricity generated by the solar plate at night so as to achieve the power saving effect.

The upper and lower sidewall bodies are configured for improving protection and aesthetics. Specifically, the upper sidewall body is installed at the sidewall of the lower part of the thin power saving billboard and further configured to contact the thin power saving billboard and enclose the respective circumference of the skeleton. The lower sidewall body is under the upper sidewall body and dose not contact the upper sidewall body, especially enclosing the respective circumference of the skeleton.

The charging unit has a slab-like shape and each charging socket is provided on the circumference of the charging unit. In addition, the electrical connection circuit is configured inside the skeleton for electrically connecting the solar plate to the thin power saving billboard and the charging sockets so as to supply power to a single one or a plurality of electronic devices for recharging operation. Particularly, each charging socket comprises an USB (Universal Serial Bus) port for connecting and charging an USB electrical device such as laptop computer, tablet computer, mobile phone, electronic game device, digital camera, voice recording pen, and so on.

Therefore, the power generating column structure of the present invention provides not only the charging function but also the advertisement displaying effect, and particularly, the vertical column structure of the present invention may further improve advertisement effect. The charging sockets are located in the open space of the intermediate charging region such that less space is occupied and the intermediate charging region forms a flat pad for easily placing and conveniently charging the electronic devices.

### BRIEF DESCRIPTION OF THE DRAWINGS

The present invention can be understood in more detail by reading the subsequent detailed description in conjunction with the examples and references made to the accompanying drawings, wherein:

FIG. 1 is a perspective exploded view showing a power generating column structure according to one embodiment of the present invention;

FIG. 2 is a perspective view showing the skeleton of the structure according to the present invention; and

FIGS. 3 to 5 are perspective views showing different kinds of the skeleton of the structure according to the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

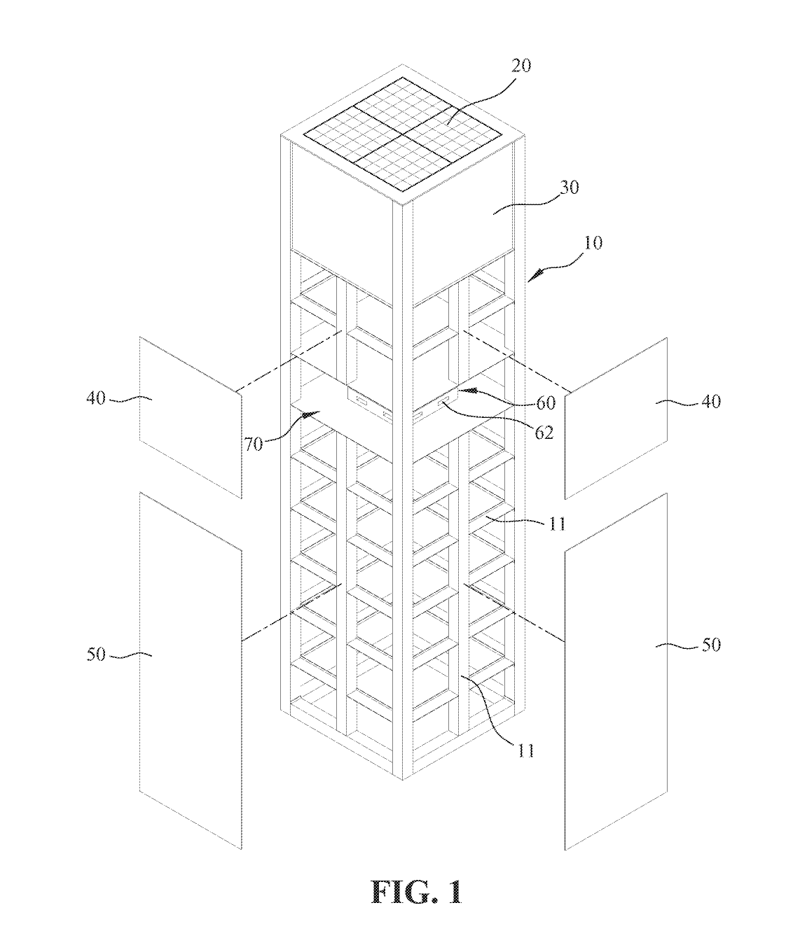

Please refer to FIG. 1 showing the power generating column structure according to one embodiment of the present invention. As shown in FIG. 1, the power generating column structure of the present invention generally comprises a skeleton 10, at least one solar plate 20, at least one thin power saving billboard 30, a plurality of upper sidewall bodies 40, a plurality of lower sidewall bodies 50, a charging unit 60, an intermediate charging region 70 and an electrical connection circuit (not shown) for providing both charging and advertisement displaying effects.

The solar plate 20, the thin power saving billboard 30 and the upper sidewall bodies 40 and the lower sidewall bodies 50 are provided on the outer surface of the skeleton 10, and the intermediate charging region 70 is located in the open space inside the middle of the power generating column structure of the present invention.

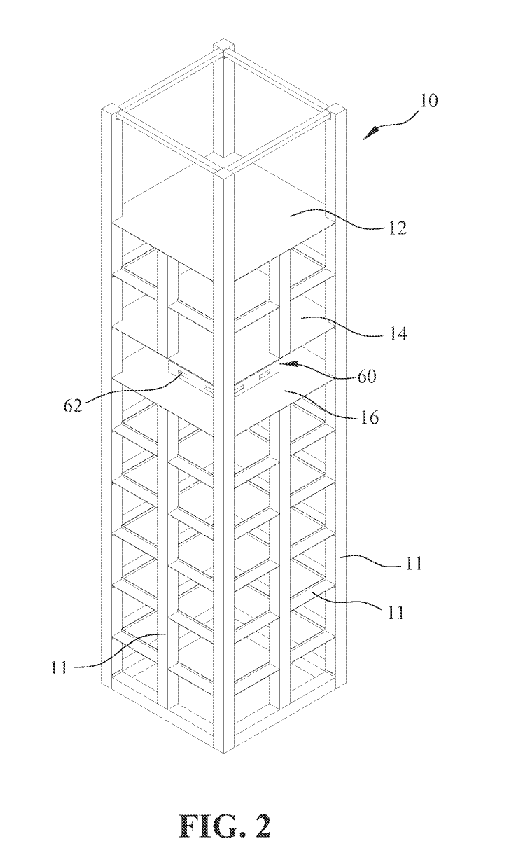

Further refer to FIG. 2 for showing the skeleton 10 of the structure according to the present invention. The skeleton 10 comprises a plurality of rod-like metal pieces 11, a first horizontal partition 12, a second horizontal partition 14 and a third horizontal partition 16. The metal pieces 11 are jointed together by means of soldering or locking to construct a vertical column having a plurality of trellis-like hollow cells on each side of the skeleton 10. For example, each metal piece 11 is tightly locked by at least one locking piece like screw. Specifically, the metal piece 11 is implemented by a solid or hollow piece made of iron, stainless steel or aluminum alloy, or alternatively a C-shaped or H-shaped piece.

The first horizontal partition 12, the second horizontal partition 14 and the third horizontal partition 16 are horizontally provided at different positions inside the vertical column. In particular, the first horizontal partition 12 is configured higher than the second horizontal partition 14, and the second horizontal partition 14 is configured higher than the third horizontal partition 16. Furthermore, a specific region sandwiched by the second horizontal partition 14 and the third horizontal partition 16 may form the intermediate charging region 70. The charging unit comprising a plurality of charging sockets is provided on the intermediate charging region 70, and each charging socket is configured for charging an electronic device (not shown).

The solar plate 20 is partly transparent and able to convert solar power into electricity. Preferably, the solar plate 20 is provided on the top surface of the skeleton 10 or on the sidewall near the top of the skeleton 10 so as to increase the effective exposure area for sunlight.

The thin power saving billboard 30 can be powered by electricity from general city power or generated by the solar plate so as to normally and clearly display various static pictures, movies or animations. The billboard 30 is preferably configured to enclose the sidewalls of the top of the skeleton 10, thereby enhancing advertisement effect. Moreover, the billboard 30 may further comprise a light guiding film (not shown). Since the solar plate 20 is partly transparent, the light passing through the solar plate 20 as a side light can be guided by light guiding film to a uniform plane light source toward the billboard 30. The plane light source is served as the light source of the billboard 30 for displaying, especially at daytime. That is, the billboard 30 is configured to use the light from the solar plate 20 as part or all of the desired light source for displaying at day so as to achieve the effect of power saving. Furthermore, the billboard 30 can operate by use of electricity generated by the solar plate 20. The present invention may further comprises an energy storage unit like chargeable lithium batteries to store electricity generated by the solar plate 20 at day and supply electricity to the billboard 30 operating at night.

Specifically, the upper sidewall bodies 40 and lower sidewall bodies 50 are configured for improving protection and aesthetics. The upper sidewall body 40 is installed at the sidewall of the lower part of the thin power saving billboard 30 and particularly contacts the thin power saving billboard 30. The respective circumference of the skeleton 10 is enclosed by the upper sidewall body 40. The lower sidewall bodies 50 are provided under the upper sidewall bodies 40 and do not contact the upper sidewall bodies 40 so as to enclose the respective circumference of the skeleton 10.

The charging unit 60 has a slab-like shape and comprises a plurality of charging sockets 62 provided on the circumference of the charging unit 60. Additionally, the electrical connection circuit is provided inside the skeleton 10 for electrically connecting the solar plate 20 to the thin power saving billboard 30 and the charging sockets 62 so as to supply electricity generated by the solar plate 20 for normal operation. Each charging socket 62 may comprise at least one USB (Universal Serial Bus) port for charging the electronic device with an USB port such as laptop computer, tablet computer, mobile phone, electronic game device, digital camera, voice recording pen, and so on.

Furthermore, the charging unit 60 possesses the wireless charging function to wireless charge the external electrical devices without using any power line or power cable. Since wireless charging has been widely applied and the related skills have become more mature and reliable, this technology will be one primary charging solution in the upcoming future, especially for handset or mobile devices. Also, portability and convenience for these devices are greatly improved. It is thus believed that a mobile device with a more compact housing structure and without any sockets, gaps or slits can be simply implemented.

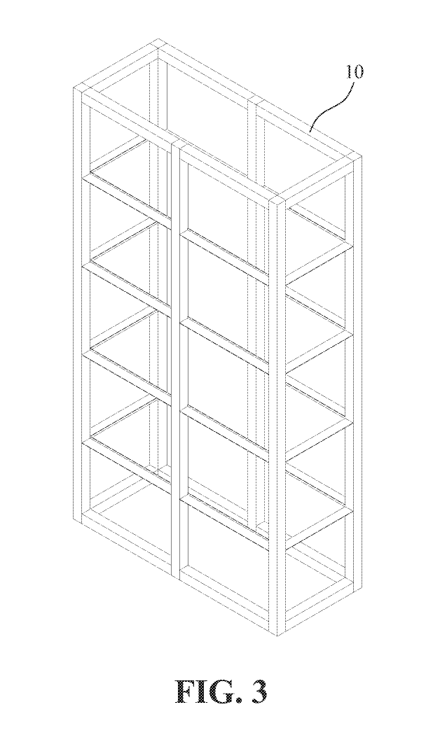

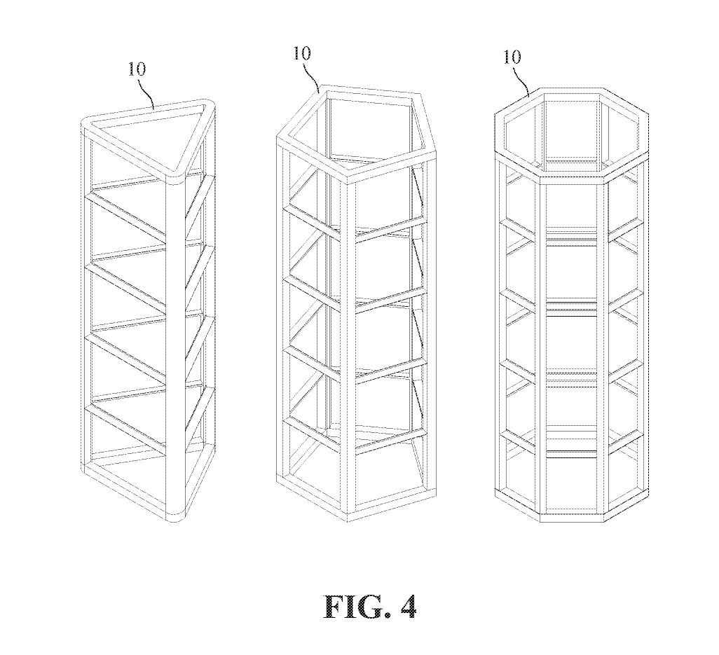

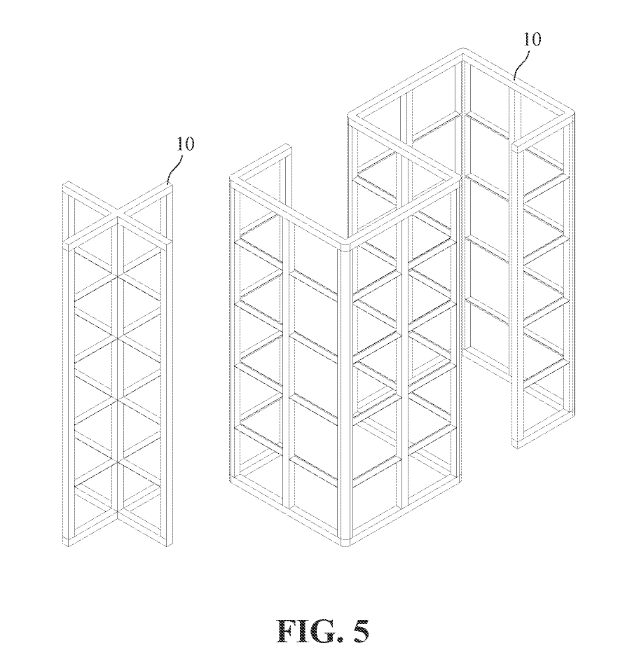

In addition, please refer to FIGS. 3 to 5 for some different kinds of the skeleton 10 of the structure according to the present invention. The skeleton 10 shown in FIG. 3 has a rectangular cross section, and the skeleton 10 shown in FIG. 4 has a cross section formed of a triangular, pentagonal or hexagonal shape. It should be noted that FIGS. 3 and 4 are only typical examples to clearly illustrate the aspects of the present invention, and not intended to limit the scope of the present invention. In other words, the skeleton 10 may have a cross section formed of any shape. In FIG. 5, the cross section of the skeleton 10 of the present invention is a crisscross shape or a shape formed of bent segments so as to form locally separate and open space regions for various applications.

The power generating column structure of the present invention is preferably installed in the indoor space of a general public occasion like train station, airport, department store, exhibition forum, office building and hotel, or alternatively can be provided at an outdoor public site such as bus stop, court, field and play ground so as to provide the similar features generated by general billboards or light boxes. Thus, not only the decorative effect of the column style and the functions of displaying advertisement, indication, guidance and propagation but also easy charging is implemented, thereby increasing industrial utility.

From the above mention, one primary feature of the present invention is that the power generating column structure can realize the object of easy charging and further provide the effect of displaying advertisement. Particularly, the vertical column structure does not occupy too much space, but greatly improves the advertisement effect. In addition, the charging socket is located at the intermediate charging region having the flat-like pad, which allows the users to easily place and charge their electronic devices, especially comfortably operating the electronic devices like editing electronic documents, so as to greatly improve convenience in use.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power generating column structure, comprising:
a skeleton comprising a plurality of rod-like metal pieces, a first horizontal partition, a second horizontal partition and a third horizontal partition, wherein the metal pieces are jointed together by means of soldering or locking to construct a vertical column having a plurality of trellis- like hollow cells on each side of the skeleton, the first, second and third horizontal partitions are horizontally provided at different positions inside the vertical column, the first horizontal partition is configured higher than the second horizontal partition, and the second horizontal partition is configured higher than the third horizontal partition;
at least one solar plate configured on part of a top surface of the skeleton, partly transparent and able to convert solar power into electricity;
at least one thin power saving billboard configured to enclose a side circumference of a top of the skeleton and powered by electricity generated by the at least one solar plate to display static pictures, movies or animations;
a plurality of upper sidewall bodies installed at a lower part of the thin power saving billboard and configured to contact the thin power saving billboard and enclose a respective circumference of the skeleton for improving protection and aesthetics;
a plurality of lower sidewall bodies provided under the upper sidewall bodies and not contact the upper sidewall bodies so as to enclose the respective circumference of the skeleton for protection and aesthetics;
a charging unit having a slab-like shape and comprising a plurality of charging sockets provided on a circumference of the charging unit, each charging socket configured for charging an electronic device;
an intermediate charging region configured at a specific region sandwiched by the second horizontal partition and the third horizontal partition, wherein the intermediate charging region is not covered by the upper and lower sidewall bodies so as to form an open space, and the charging unit is provided on the third horizontal partition within the intermediate charging region; and
an electrical connection circuit configured inside the skeleton for electrically connecting the at least one solar plate to the thin power saving billboard and the charging sockets so as to supply power for operation.

2. The power generating column structure as claimed in claim 1, wherein the at least one solar plate is provided on an outer surface of the top of the skeleton.

3. The power generating column structure as claimed in claim 1, wherein the thin power saving billboard comprises a light guiding film for converting a side light from the at least one solar plate into a plane light source served as the light source for displaying.

4. The power generating column structure as claimed in claim 1, wherein the charging socket comprises at least one USB (Universal Serial Bus) port.

5. The power generating column structure as claimed in claim 1, wherein the skeleton has a cross section of a triangle, pentagon or hexagon shape.

6. The power generating column structure as claimed in claim 1, wherein the skeleton has a cross section of a crisscross shape or a shape formed of bent segments so as to form locally separate and open space regions.

7. The power generating column structure as claimed in claim 1, wherein the charging unit further comprises a wireless charging function for wireless charging external electrical devices.
